(19) United States
(12) Patent Application Publication
(10) Pub. No.: US 2009/0117841 A1
(43) Pub. Date: May 7, 2009

(54) Air conditioner for vehicle

(75) Inventors: Yoshihiro Goto, Chita-gun (JP); Koji Ito, Nagoya-city (JP); Yoshihiko Okumura, Kariya-city (JP); Koji Wakabayashi, Anjo-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/290,436

(22) Filed: Oct. 30, 2008

(30) Foreign Application Priority Data
Nov. 2, 2007 (JP) 2007-285868

(51) Int. Cl. B60H 1/00

(52) U.S. Cl. 454/127; 454/161

(57) ABSTRACT

In a vehicle air conditioner, first and second downstream side passages are provided in an air conditioning case to guide air to a defroster opening and a foot opening, respectively. A switching door is capable of switching between a partition position for partitioning the first downstream side passage and the second downstream side passage from each other, and a communication position for establishing communication between the first downstream side passage and the second downstream side passage. An air outlet mode switching device is capable of switching between a foot mode and a foot/defroster mode. In the foot mode, the air outlet mode switching device causes both the foot door and defroster door to be opened and causes the first switching door to be set at the partition position. Therefore, it is possible to prevent a problem due to an air outlet mode door with a small opening degree.

### CROSS REFERENCE TO RELATED APPLICATION

This application is based on Japanese Patent Application No. 2007-285868 filed on Nov. 2, 2007, the contents of which are incorporated herein by reference in its entirety.

### FIELD OF THE INVENTION

The present invention relates to an air conditioner for a vehicle.

### BACKGROUND OF THE INVENTION

A conventional air conditioner for a vehicle is configured to distribute conditioned air into air outlet openings provided in an air conditioning case, by using an air outlet mode door for opening and closing the air outlet openings.

In a foot mode, the vehicle air conditioner is generally adapted to blow out conditioned air toward the foot area of a passenger in a passenger compartment of the vehicle through a foot opening, while blowing out a small amount of air toward a vehicle windshield through a defroster opening, thereby preventing fogging of the windshield.

When the air outlet mode door is set at a position to have a small opening degree, specifically, in the above-described foot mode, a small gap formed in the defroster opening drastically restricts an air flow. In this case, the air is injected from the small gap at a high velocity, thereby causing abnormal noise such as window roar or the like.

The small opening-degree position of the air outlet mode door varies because the opening degree changes depending on variations in the accuracy of parts, assembly, or the like. Thus, the conditioned air from a corresponding air outlet opening such as the defroster opening may excessively leak from or may be excessively restricted, thereby deteriorating the air conditioning feeling of the passenger or causing a window fogging.

### SUMMARY OF THE INVENTION

In view of the foregoing problems, it is an object of the present invention to provide an air conditioner for a vehicle, which can prevent occurrence of problems caused due to a small opening-degree position of an air outlet mode door.

According to an aspect of the present invention, an air conditioner for a vehicle includes an air conditioning case defining therein an air passage through which air flows toward an inside of a passenger compartment of the vehicle, a foot opening portion provided in the air conditioning case from which air is blown out toward a lower side in the passenger compartment, a foot door configured to open and close the foot opening portion, a defroster opening portion provided in the air conditioning case from which air is blown toward a windshield of the vehicle, a defroster door configured to open and close the defroster opening portion, a first downstream side passage provided in the air passage of the air conditioning case to guide air to the defroster opening portion, a second downstream side passage provided in the air passage of the air conditioning case to guide air to the foot opening portion, a first switching door and an air outlet mode switching device. The first switching door is configured to be capable of switching between a partition position for partitioning the first downstream side passage and the second downstream side passage from each other, and a communication position for establishing communication between the first downstream side passage and the second downstream side passage. The air outlet mode switching device is configured to be capable of switching between a foot mode in which air is mainly blown from at least one foot opening portion while a small amount of air is blown from the defroster opening portion, and a foot/defroster mode in which a flow amount of air blown from the foot opening portion is decreased thereby to increase a flow amount of air blown from the defroster opening portion as compared with the foot mode. In the air conditioner, in the foot mode, the air outlet mode switching device opens both the foot door and the defroster door and sets the first switching door in the partition position to guide air passing through the first downstream side passage to the defroster opening portion, and to guide air passing through the second downstream side passage to the foot opening portion. Furthermore, in the foot/defroster mode, the air outlet mode switching device opens both the foot door and the defroster door and sets the first switching door in the communication position to guide air passing through the first downstream side passage and a part of air passing through the second downstream side passage to the defroster opening portion, and to guide the remaining air passing through the second downstream side passage to the foot opening portion.

Accordingly, in the foot mode, the first switching door partitions the air passage of the air conditioning case into first and second passages such as the first downstream side passage and the second downstream side passage, and thereby the flow amount of air flowing into the defroster opening portion can be made smaller than the flow amount of air blown out from the foot opening portion without setting the defroster door at a small opening degree position.

Thus, an occurrence of abnormal noise due to the small opening degree position of an air outlet mode door such as the defroster door can be suppressed. Further, because the defroster door does not need to be set at the small opening degree position, it is possible to prevent conditioned air from excessively leaking due to variations in small opening degree positions of the defroster door.

In contrast, in the foot/defroster mode, the first switching door communicates the first downstream side passage with the second downstream side passage, thereby allowing the air to flow from the second downstream side passage into the first downstream side passage. Thus, in the foot/defroster mode, the flow amount of air blown from the defroster opening portion can be made larger, as compared to in the foot mode.

For example, the air conditioning case may be further provided with a face opening portion from which air is blown toward an upper side in the passenger compartment, and a face door configured to open and close the face opening portion. The first downstream side passage can be provided to guide air in the first downstream side passage to the face opening portion in addition to the defroster opening portion. In this case, in the foot mode, the air outlet mode switching device opens all the face door, the foot door and the defroster door, and causes the first switching door to be set at the partition position to guide air passing through the first downstream side passage to both the defroster opening portion and the face opening portion, and to guide air passing through the second downstream side passage to the foot opening portion.

Alternatively, the first downstream side passage can be provided to guide air in the first downstream side passage to the defroster opening portion. In this case, in the foot mode, the air outlet mode switching device closes the face door and opens the foot door and the defroster door, and causes the first switching door to be set at the partition position to guide air passing through the first downstream side passage to the defroster opening portion, and to guide air passing through the second downstream side passage to the foot opening portion.

The air conditioner for a vehicle may further include a cooling heat exchanger located in the air conditioning case to cool air, a heating heat exchanger located in the air conditioning case to heat air after passing through the cooling heat exchanger, and a partition member configured to partition the air passage between the cooling heat exchanger and the heating heat exchanger into first and second upstream side passages. In this case, the first downstream side passage allows the air having passed through the first upstream side passage and the heating heat exchanger to flow thereinto, and the second downstream side passage allows the air having passed through the second upstream side passage and the heating heat exchanger to flow thereinto. Furthermore, the partition member may be configured such that a flow amount of the air passing through the first upstream side passage is smaller that a flow amount of the air passing through the second upstream side passage. In this case, the first downstream side passage and the second downstream side passage are generally provided in the air conditioning case downstream of the heating heat exchanger.

The heating heat exchanger may be a single integrated heat exchanger. In this case, the heating heat exchanger may be disposed, such that the air passing through the first upstream side passage flows into a part of the heating heat exchanger on one end side, and the air passing through the second upstream side passage flows into another part of the heating heat exchanger on the other end side.

Alternatively, the heating heat exchanger may include first and second heater cores separated from each other. In this case, the first heater core is disposed to allow the air passing through the first upstream side passage to flow thereinto, and the second heater core is disposed to allow the air passing through the second upstream side passage to flow thereinto.

Furthermore, the second downstream side passage in the air conditioning case may be provided with a front seat air passage and a rear seat air passage. In this case, the air conditioner may be further provided with a second switching door that is configured to be switched between a partition position for separating the front seat air passage from the rear seat air passage, and a communication position for establishing communication between the front air passage and the rear seat air passage. In this case, the foot opening portion includes a front seat foot opening for allowing the air having passed through the front seat air passage to be blown out toward the lower body of a passenger on a front seat in the passenger compartment, and a rear seat foot opening for allowing the air having passed through the rear seat air passage to be blown out toward the lower body of a passenger on a rear seat in the passenger compartment. Furthermore, the foot door includes a front seat foot door configured to open and close the front seat foot opening and a rear seat foot door configured to open and close the rear seat foot opening, and the second switching door is set at the partition position when both the front seat foot door and the rear seat foot door are opened.

According to the above-described examples of the present invention, the air outlet mode switching device may be configured to fully open the foot door and to open the defroster door by an opening degree larger than a predetermined degree, in the foot mode. Alternatively, the air outlet mode switching device may be configured to fully open the foot door and to open the defroster door by an opening degree equal to or larger than half, in the foot mode. Alternatively, the air outlet mode switching device may be configured to fully open both the foot door and the defroster door, in the foot mode and in the foot/defroster mode.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a schematic sectional view of an air conditioning unit in a foot mode according to a first embodiment of the present invention;

FIG. 2 is a diagram showing air flow ratios to be distributed into plural air outlet openings in various air outlet modes and operation patterns of air outlet mode doors, according to the first embodiment;

FIG. 3 is a schematic sectional view showing the air conditioning unit in a foot/defroster mode according to the first embodiment;

FIG. 4 is a schematic sectional view showing the air conditioning unit in a face mode according to the first embodiment;

FIG. 5 is a schematic sectional view showing the air conditioning unit in a bi-level mode according to the first embodiment;

FIG. 6 is a schematic sectional view showing the air conditioning unit in a defroster mode according to the first embodiment;

FIG. 7 is a schematic sectional view showing an air conditioning unit in a multi-foot mode according to a second embodiment of the present invention;

FIG. 8 is a schematic sectional view showing an air conditioning unit in a foot mode according to a third embodiment of the present invention;

FIGS. 9A and 9B are schematic sectional views each showing an air conditioning unit in a multi-foot mode according to a fourth embodiment of the present invention;

FIG. 10 is a schematic sectional view showing a downstream air portion of a lower heater core in the air conditioning unit according to the fourth embodiment;

FIG. 11 is a schematic sectional view showing an air conditioning unit in a foot mode according to a fifth embodiment of the present invention; and

FIG. 12 is a schematic sectional view showing an air conditioning unit in a multi-foot mode according to a sixth embodiment of the present invention.

### DETAILED DESCRIPTION OF THE PREFERRED EMBODIMENTS

### First Embodiment

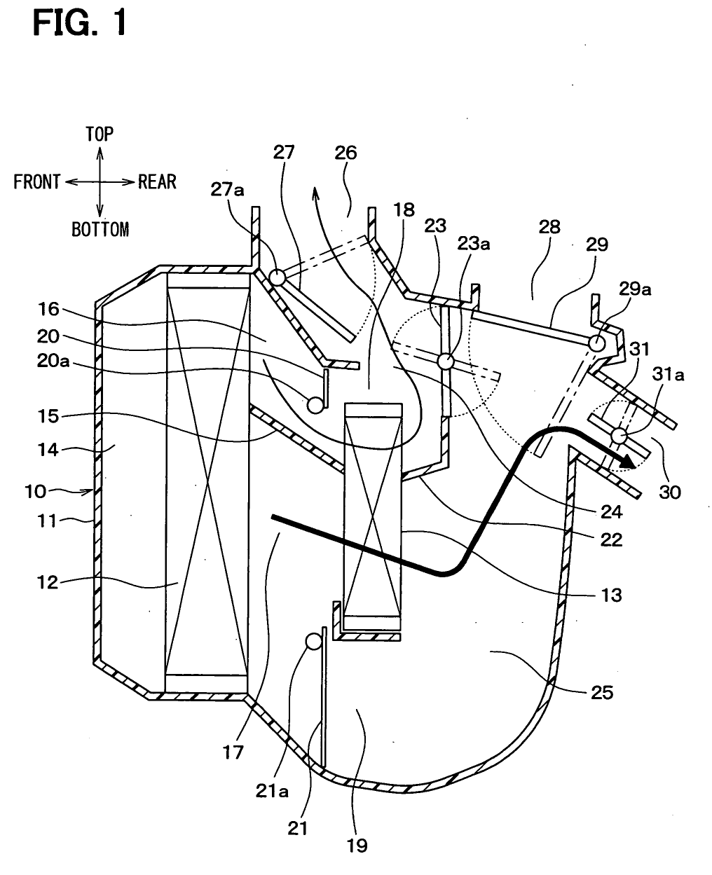

A first embodiment of the present invention will be described below based on FIGS. 1 to 6. An air conditioner for a vehicle according to the present embodiment is mainly divided into two parts, namely, an air conditioning unit 10 shown in FIG. 1, and a blower unit (not shown) for blowing air to the air conditioning unit 10.

The blower unit is disposed in an instrument panel (i.e., dashboard) at the front of a passenger compartment of the vehicle to be offset from a center area to a front passenger seat side in a vehicle left-right direction (vehicle width direction). On the other hand, the air conditioning unit 10 is disposed inside of the instrument panel (not shown) at the front of the passenger compartment substantially at the center area in the vehicle left-right direction.

The blower unit includes an inside/outside air switching box that is configured to selectively introduce outside air (i.e., air outside the passenger compartment) and inside air (i.e., air inside the passenger compartment), and a centrifugal blower for blowing air introduced through the inside/outside air switching box, as is known generally.

The air conditioning unit 10 includes a resinous air conditioning case 11 defining an air passage through which air is blown toward the inside of the passenger compartment. The air conditioning unit 10 integrally incorporates, in the air conditioning case 11, both an evaporator 12 serving as a heat exchanger for cooling, and a heater core 13 serving as a heat exchanger for heating. The air conditioning unit 10 is mounted substantially at the center area of the inside of the instrument panel to be positioned in a state shown in FIG. 1 with respect to the front-rear direction and the top-bottom direction of the vehicle, for example.

An air inlet space 14 is formed at the vehicle frontmost part of the inside of the air conditioning case 11. The air blown from the centrifugal blower of the blower unit flows into the air inlet space 14 of the air conditioning case 11.

The evaporator 12 is disposed at a position directly after the air inlet space 14 in the air conditioning case 11. The evaporator 12 is adapted to absorb evaporation latent heat of a low-pressure refrigerant in a refrigerant cycle from blown air, thereby cooling the blown air, as being known generally. That is, the evaporator 12 is a component of the refrigerant cycle, and is configured such that the low-pressure refrigerant is evaporated in the evaporator 12 by absorbing heat from air passing through the evaporator 12. Therefore, the air passing through the evaporator 12 is cooled. The heater core 13 is disposed on an air flow downstream side of the evaporator 12 (e.g., on a vehicle rear side of the evaporator 12 in FIG. 1) with a predetermined distance spaced from the evaporator 12.

The heater core 13 is adapted to heat the cooled air having passing through the evaporator 12. High-temperature hot water (engine coolant) from a vehicle engine (not shown) flows through the heater core 13. The heater core 13 is adapted to heat the air using the hot water as a heat source. The heater core 13 has a core portion for heat exchange which includes flat tubes for allowing the hot water to pass therethrough and a corrugated fin connected to the tubes.

An inlet tank for allowing the hot water to flow into the tubes of the heater core 13 is disposed on a lower side of the core portion for heat exchange, and an outlet tank for allowing the hot water to flow out of the tubes of the heater core 13 is disposed on an upper side of the core portion for heat exchange.

An air passage, through which air passes on an upstream air side of the heater core 13, is partitioned by an upstream side partition member 15 disposed in the air conditioning case 11 into a first upstream side passage 16 and a second upstream side passage 17. In the present embodiment, the first upstream side passage 16 is positioned above the upstream side partition member 15, and the second upstream side passage 17 is positioned below the upstream side partition member 15, in the air conditioning case 11. The upstream side partition member 15 is an example of a partition member of the present invention.

The upstream side partition member 15 is formed to extend from the air outlet of the evaporator 12 to the air inlet of the heater core 13 over the entire length of the internal space of the air conditioning case 11 in the vehicle left-right direction (i.e., in the direction orthogonal to the paper face of FIG. 1). The heater core 13 is partitioned into an upper part and a lower part by the upstream side partition member 15 and a downstream side partition member 22 to be described later.

A first bypass passage 18 and a second bypass passage 19, through which the air (cooled air) after passing through the evaporator 12 bypasses the heater core 13 are provided above and below the heater core 13, respectively, in the air passage inside the air conditioning case 11. That is, the first bypass passage 18 is located adjacent to the upper part of the heater core 13, and the second bypass passage 19 is located adjacent to the lower part of the heater core 13, as shown in FIG. 1.

The second upstream side passage 17 on the upstream side of the heater core 13 is formed to have a passage sectional area larger than that of the first upstream side passage 16. For example, the passage sectional area of the first upstream side passage 16 and the passage sectional area of the second upstream side passage 17 are formed at a ratio of 1 to 9.

Likewise, the lower part of the heater core 13 and the second bypass passage 19 are formed to have a passage sectional area larger than that of the upper part of the heater core 13 and the first bypass passage 18.

Thus, the flow amount of air passing through the upper part of the heater core 13 and the first bypass passage 18 is small as compared to the flow amount of air passing through the lower part of the heater core 13 and the second bypass passage 19.

A first air mix door 20 and a second air mix door 21 are respectively disposed between the evaporator 12 and the heater core 13. Each of the air mix doors 20 and 21 is constructed of a flat plate-shaped sliding door, for example.

The sliding door constituting each of the air mix doors 20 and 21 in the present embodiment is a generally known flat plate-shaped sliding door. The sliding door is configured to be moved in the direction intersecting the air flow in the air passage by a driving transmission mechanism, including driving gears 20a, 21a, and the like, thereby opening and closing the air passage.

Specifically, the first air mix door 20 is movable vertically in the air conditioning case 11 so as to respectively get across the first bypass passage 18 and the upper part of the heater core 13. The movement of the first air mix door 20 can arbitrarily adjust a ratio of the flow amount of air heated at the upper part of the heater core 13 to the flow amount of air bypassing the heater core 13 through the first bypass passage 18.

Likewise, the second air mix door 21 is movable vertically in the air conditioning case 11 so as to respectively get across the second bypass passage 19 and the lower part of the heater core 13. The movement of the second air mix door 21 can arbitrarily adjust a ratio of the flow amount of air heated at the lower part of the heater core 13 to the flow amount of air bypassing the heater core 13 through the second bypass passage 19.

In the present embodiment, the first air mix door 20 serves as a temperature adjustment portion which is capable of independently adjusting a temperature of air blown out toward the windshield in the passenger compartment by adjustment of an air flow amount ratio as described above. The second air mix door 21 serves as a temperature adjustment portion which is capable of independently adjusting a temperature of air blown out toward a passenger side (i.e., the front seat side) in the passenger compartment by adjustment of the air flow amount ratio.

The downstream side partition member 22 is provided on the downstream air side (e.g., vehicle rear side) of the heater core 13 to extend upward from a position on an extension line of the vehicle rear end of the upstream side partition member 15 that is positioned on the upstream air side of the heater core 13.

A first switching door 23 is provided so as to extend from the tip of the downstream side partition member 22 toward an upper wall surface of the air conditioning case 11 at a position between a defroster opening 26 and a face opening 28 to be described later. That is, as shown in FIG. 1, the downstream side partition member 22 has a downstream side end away from the heater core 13, and the first switching door 23 can be rotated to a position (solid line position in FIG. 1) so as to extend from the downstream end of the downstream side partition member 22 toward the upper wall surface of the air conditioning case 11 at a position between the defroster opening 26 and the face opening 28. The first switching door 23 is rotatably disposed with a rotary shaft 23a centered.

A first downstream side passage 24 for guiding air to the defroster opening 26 to be described later and a second downstream side passage 25 for guiding air to the face opening 28 and a foot opening 30 to be described later can be formed in the air conditioning case 11 to be partitioned from each other by the downstream side partition member 22 and the first switching door 23. The first downstream side passage 24 of FIG. 1 is an example of a first air passage of the present invention, and the second downstream side passage 25 of FIG. 1 is an example of a second air passage of the present invention. The first air passage and the second air passage of the present invention are capable of being partitioned from each other in the foot mode, and are capable of communicating with each other in an air outlet mode other than the foot mode. That is, the downstream side partition member 22 and the first switching door 23 are configured to partition the first downstream side passage 24 and the second downstream side passage 25 from each other and to communicate the first downstream side passage 24 and the second downstream side passage 25 with each other.

When the first switching door 23 is rotated to the position indicated by the solid line shown in FIG. 1, the first switching door 23 interrupts a communication between the first downstream side passage 24 and the second downstream side passage 25. Thus, the position indicated by the solid line shown in FIG. 1 is a “partition position” of the first switching door 23. In this case, the first downstream side passage 24 and the second downstream side passage 25 are partitioned from each other. In contrast, when the first switching door 23 is operated to a position other than the solid line position, for example, a position indicated by a dashed line shown in FIG. 1, the first switching door 23 causes the first downstream side passage 24 to communicate with the second downstream side passage 25. Thus, the position indicated by the dashed line shown in FIG. 1 is an example of a “communication position” of the first switching door 23.

The first downstream side passage 24 forms an air mixing portion for mixing cooled air passing through the first bypass passage 18 with warm air passing through the upper part in the heater core 13. That is, the first downstream side passage 24 has therein the air mixing portion. The defroster opening 26 is opened at the upper surface of the air conditioning case 11 and above the air mixing portion in the first downstream side passage 24.

The defroster opening 26 is connected to a defroster duct (not shown) at the tip of which a defroster outlet (not shown) is provided. From the defroster outlet, the conditioned air is blown out toward the inner surface of the windshield of the vehicle. The defroster opening 26 is opened and closed by a plate-shaped defroster door 27 which is rotatable around the rotary shaft 27a, for example.

The second downstream side passage 25 forms an air mixing portion for mixing cooled air passing through the second bypass passage 19 with warm air passing through the lower part in the heater core 13. Thus, the first switching door 23 configured so as to establish communication between the first downstream side passage 24 and the second downstream side passage 25 can cause the air mixing portion in the first downstream passage 24 to communicate with the air mixing portion in the second downstream side passage 25.

The face opening 28 is provided at the upper surface of the air conditioning case 11 and above the air mixing portion in the second downstream side passage 25. The face opening 28 is provided at a position on the rear side of the vehicle, near the passenger in the passenger compartment with respect to the defroster opening 26.

The face opening 28 is coupled to a face air outlet (not shown) provided on the upper side of the instrument panel via a face duct (not shown). The conditioned air is blown out from the face air outlet toward the upper body of the passenger in the passenger compartment. The face opening 28 is opened and closed by a plate-shaped face door 29 which is rotatable around a rotary shaft 29a. The face opening 28 is provided for a front seat side, for blowing the conditioned air therefrom toward the upper body of the passenger on the front seat side in the passenger compartment of the vehicle.

The foot opening 30 is provided below the face opening 28 in the air conditioning case 11. The foot opening 30 is connected to a foot duct (not shown). A foot air outlet (not shown) is provided at the lower end of the foot duct. The conditioned air is blown out from the foot air outlet toward the passenger's foot area in the passenger compartment. The foot opening 30 is opened and closed by a plate-shaped foot door 31 which is rotatable around the rotary shaft 31a. The foot opening 30 is provided for the front seat side, for blowing the conditioned air toward the passenger's foot area on a front seat in the passenger compartment.

The defroster door 27, the face door 29, and the foot door 31 as described above are air outlet mode doors, and operatively linked with an output shaft of a common actuator via a link mechanism (not shown) in cooperation with the first switching door 23. Thus, the air outlet mode doors 27, 29, and 31, and the first switching door 23 are operatively linked with each other by the common actuator mechanism.

The link mechanism and the actuator are also included in an air outlet mode switching device, which is controlled by a controller (not shown). The air outlet mode switching device described in the present embodiment is an example, and can be suitably changed to set an air outlet mode.

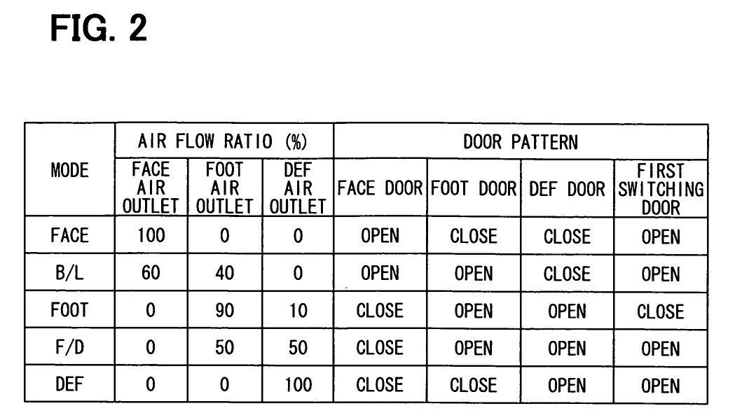

Now, the operation of the vehicle air conditioner with the above structure according to the present embodiment will be described below. In the present embodiment, as shown in FIG. 2, the air outlet mode switching device is configured to be capable of switching among a face mode (FACE), a bi-level mode (B/L), a foot mode (FOOT), a foot/defroster mode (F/D), and a defroster mode (DEF). The open and close patterns of the air outlet mode doors 27, 29, and 31, and the first switching door 23, and the ratios of flow amounts of air from the respective air outlet openings can be set in the respective air outlet modes, for example, as shown in FIG. 2.

FIG. 1 shows a case of setting, as the air outlet mode, the foot mode in which the conditioned air is mainly blown from the foot opening 30, while a small amount of the conditioned air is blown from the defroster opening 26. In the foot mode, in order to heat the lower body of a passenger in the passenger compartment in maximum, the first and second air mix doors 20 and 21 are located, for example, at the maximum heating positions at which the first and second bypass passage 18 and 19 are closed.

In the foot mode, the defroster opening 26 and the foot opening 30 are fully opened by the respective air outlet mode doors 27 and 31, and the face opening 28 is closed by the face door 29. The opening degree of the defroster opening 26 is not limited to the full opening degree, and may be, for example, substantially a half-opening degree at which the defroster door 27 is not positioned at a small opening-degree position. Alternatively, the opening degree of the defroster opening 26, larger than a predetermined small opening degree (e.g., 5-30%), can be set.

In cooperation with switching into the foot mode, the first switching door 23 is operated to the “partition position” for separating the first downstream side passage 24 from the second downstream side passage 25 on the downstream air side of the heater core 13 as indicated by the solid line in FIG. 1.

In this state, when the blower of the blower unit and the refrigerant cycle are operated, the air blown from the blower unit flows into the air inlet space 14 on the frontmost side of the case 11, and is then cooled by the evaporator 12 to become cooled air.

In the maximum heating state, the cooled air flows into the upper part in the heater core 13 from the first upstream side passage 16 to become warm air. The warm air is blown out toward the vehicle windshield via the first downstream side passage 24, the defroster opening 26, the defroster duct, and the defroster air outlet in that order.

At the same time, the cooled air flows from the second upstream side passage 17 into the lower end in the heater core 13 to become warm air. The warm air is blown out toward the lower body of the passenger via the second downstream side passage 25, the foot opening 30, the foot duct, and the foot air outlet in that order.

The upstream side partition member 15 is formed such that the passage sectional area of the second upstream side passage 17 is larger than that of the first upstream side passage 16. Thus, the cooled air from the evaporator 12 mainly flows through the second upstream side passage 17, while the small amount of cooled air flows through the first upstream side passage 16.

Accordingly, the conditioned air (warm air) is mainly blown out from the foot opening 30 via the second downstream side passage 25, and thereby it is possible to reduce the flow amount of air flowing into the defroster opening 26 via the first downstream side passage 24 without causing the defroster door 27 to be set at the small opening degree position. The ratio of the flow amount of air blown from the defroster opening (defroster air outlet) 26 to the flow amount of air blown from the foot opening 30 (foot air outlet) 30 can be, for example, 1:9. That is, in the foot mode, the ratio of the flow amount of air blown from defroster air outlet to the flow amount of air blown from the foot air outlet can be set at about 1:9, without setting the opening degree of the defroster door 27 at the small opening degree. For example, the defroster door 27 can be fully opened or can be opened by an opening degree larger than a half-opening degree, in the foot mode.

In the foot mode, the first air mix door 20 is located in the first downstream side passage 24, and the second air mix door 21 is located in the second downstream side passage 25, so that the temperatures of air flowing into the defroster opening 26 and the temperature of air flowing into the foot opening 30 can be independently adjusted.

As a result, the ratio of the flow amount of air flowing from the defroster opening 26 to the flow amount of air flowing from the foot opening 30 in the foot mode can be adjusted to an appropriate value, while suppressing an occurrence of abnormal noise or the like due to the defroster door 27 operated to the small opening degree position.

Now, the foot/defroster (F/D) mode will be described below by comparison with the foot mode. In the foot/defroster mode, the flow amount of air passing through the defroster opening 26 is increased, and the flow amount of air passing through the foot opening 30 is decreased as compared with the foot mode, so that the flow amount of air blown from the defroster opening 26 is substantially equal to the flow amount of air blown from the foot opening 30.

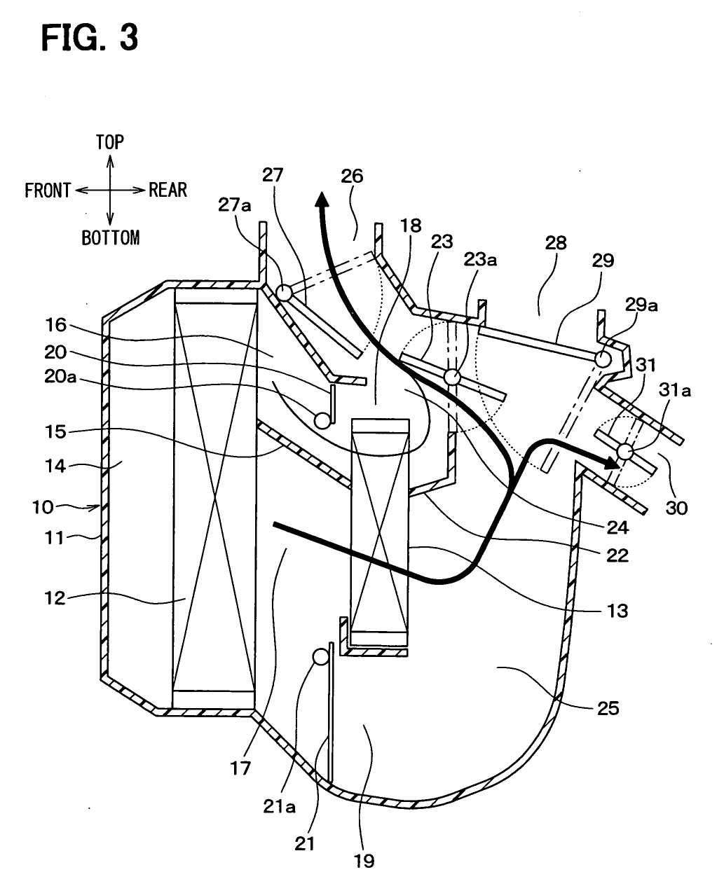

FIG. 3 shows a case of setting the foot/defroster mode as the air outlet mode. In the foot/defroster mode, the first and second air mix doors 20 and 21 can be set at the maximum heating positions for completely closing the first and second bypass passages 18 and 19, as an example sown in FIG. 3. However, it is possible to adjust the opening degrees of the first and second air mix doors 20 and 21 during the foot/defroster mode.

In the foot/defroster mode, as shown in FIG. 3, the foot opening 30 and the defroster opening 26 are fully opened by the respective air outlet mode doors 27 and 31, and the face opening 28 is closed by the face door 29, similarly to the foot mode.

In accordance with the mode switching to the foot/defroster mode, the first switching door 23 is operated in the “communication position” for establishing communication between the first downstream side passage 24 and the second downstream side passage 25 on the downstream air side of the heater core 13 as indicated by the solid line in FIG. 3. That is, the first switching door 23 causes the air mixing portion in the first downstream side passage 24 to communicate with the air mixing portion in the second downstream side passage 25.

In this state, the air blown from the blower unit flows into the air inlet space 14, and is then cooled by the evaporator 12 to become cooled air. The cooled air from the evaporator 12 flows into the upper part of the heater core 13 from the first upstream side passage 16 to become warm air. The warm air is blown out toward the vehicle windshield via the first downstream side passage 24 with the air mixing portion, the defroster opening 26, the defroster duct, and the defroster air outlet in that order.

At the same time, the cooled air flows from the second upstream side passage 17 into the lower part of the heater core 13 to become warm air, and flows into the second downstream side passage 25 with the air mixing portion. The warm air in the second downstream side passage 25 flows through the foot opening 30, and also flows through the defroster opening 26 because the first downstream side passage 24 is in communication with the second downstream side passage 25 via the opening due to the first switching door 23. Thus, the air flows into the defroster opening 26 not only from the first downstream side passage 24, but also from the second downstream side passage 25.

In the present embodiment, the upstream side partition member 15 is provided such that the passage sectional area of the second upstream side passage 17 is larger than the passage sectional area of the first upstream side passage 16. Even when the partition member 15 is located as described above, the foot/defroster mode is possible to increase the flow amount of air passing through the defroster opening 26 while decreasing the flow amount of air passing through the foot opening 30, as compared with the foot mode,

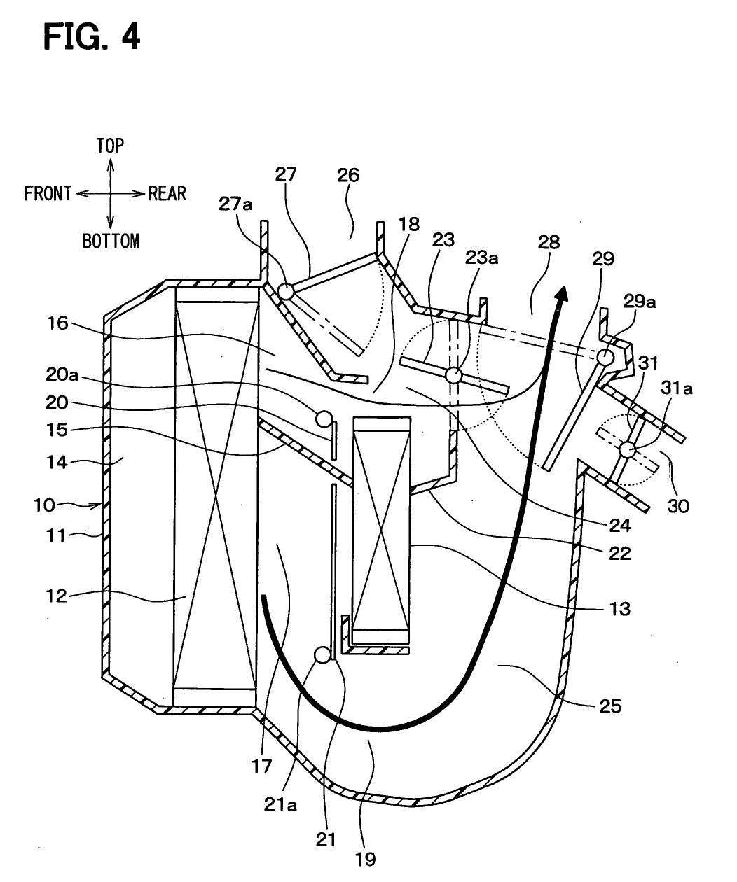

FIG. 4 shows a face mode set as the air outlet mode. In the face mode, the conditioned air is blown toward the upper body of the passenger in the passenger compartment via the face opening 28. In the example of FIG. 4, the first and second air mix doors 20 and 21 are positioned at the maximum cooling positions at which the upper part and lower part of the heater core 13 are completely closed. The maximum cooling operation shown in FIG. 4 is an example in the face mode, and the positions of the first and second air mix doors 20 and 21 can be suitably adjusted in the face mode.

In the face mode, the face opening 28 is fully opened by the face door 29, and the foot opening 30 and the defroster opening 26 are completely closed by the respective air outlet mode doors 27 and 31.

In cooperation with the switching to the face mode, the first switching door 23 is operated in the “communication position” for communicating the first downstream side passage 24 with the second downstream side passage 25 on the downstream side of the heater core 13 as indicated by the solid line in FIG. 4. In the face mode shown in FIG. 4, the air blown from the blower unit flows into the air inlet space 14, and is then cooled by the evaporator 12 to become the cooled air.

The cooled air passes through the first bypass passage 18 via the first upstream side passage 16, and flows through the first downstream side passage 24, and the face opening 28 in that order. At the same time, the air passes through the second bypass passage 19 via the second upstream side passage 17, and flows through the second downstream side passage 25 and the face opening 28 in that order. The air is blown out toward the upper body of the passenger via the face opening 28 and the face air outlet of the face duct.

Thus, the upstream side partition member 15 is provided such that the passage sectional area of the second upstream side passage 17 is larger than that of the first upstream side passage 16. Even in this case, it is possible to cause all cooled air having passing through the first and second upstream side passages 16 and 17 to flow into the face opening 28 in the face mode.

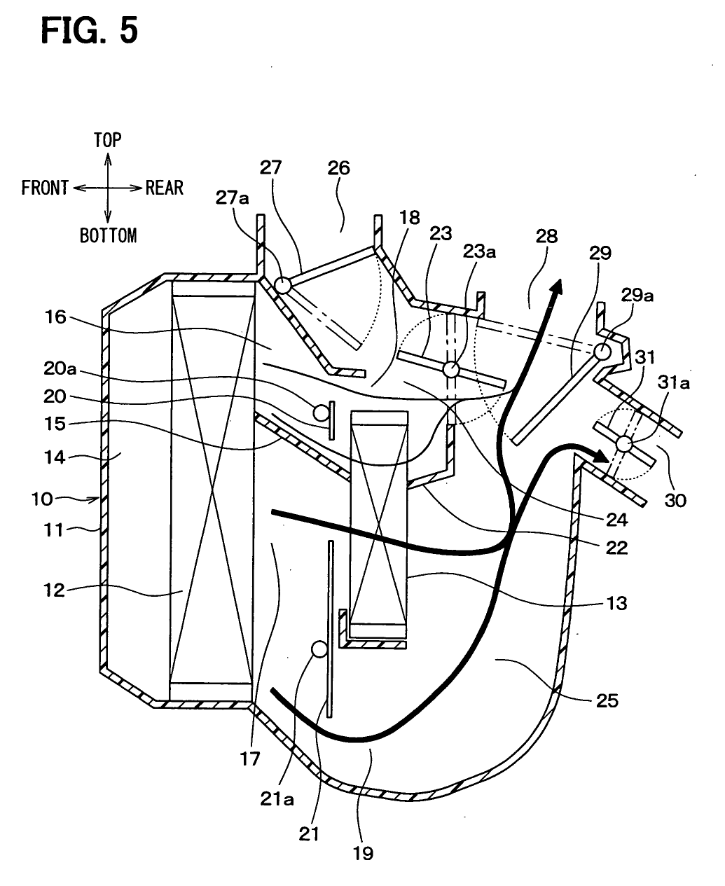

FIG. 5 shows a bi-level mode set as the air outlet mode, in which the face opening 28 and the foot opening 30 are simultaneously opened. In the bi-level mode, the first and second air mix doors 20 and 21 are operated at intermediate temperature positions for half opening the upper part and lower part of the heater core 13, as well as the first and second bypass passages 18 and 19, for example. In the bi-level mode, the opening degrees of the first and second air mix doors 20 and 21 can be suitably adjusted without being limited to the example in FIG. 5.

In the bi-level mode, the face opening 28 and the foot opening 30 are fully opened by the respective air outlet mode doors 29 and 31, and the defroster opening 26 is completely closed by the defroster door 27.

In cooperation with the switching to the bi-level mode, the first switching door 23 is operated to the “communication position” for communicating the first downstream side passage 24 with the second downstream side passage 25 on the downstream side of the heater core 13 as indicated by the solid line in FIG. 5.

In this state, the air blown from the blower unit flows into the air inlet space 14, and is then cooled by the evaporator 12 to become cooled air.

The cooled air in the first upstream side passage 16 is divided by the first air mix door 20 into air passing through the first bypass passage 18, and air passing through the upper part of the heater core 13. The cooled air from the first bypass passage 18 and the warm air from the upper part in the heater core 13 are mixed at the air mixing portion in the first downstream side passage 24, and flow from the first downstream side passage 24 to the second downstream side passage 25 communicating with the first downstream side passage 24. Then, the air mixed at the air mixing portion in the first passage 24 mainly flows into the face opening 28.

At the same time, the cooled air in the first upstream side passage 17 is divided into air passing through the second bypass passage 19 and air passing through the lower part of the heater core 13, by the position of the second air mix door 21. The cooled air passing through the second bypass passage 19 and the warm air passing through the lower part of the heater core 13 are mixed at the air mixing portion in the second downstream side passage 25 to flow into the foot opening 30 and also flow into the face opening 28. Thus, the air flows into the face opening 28 from both the first downstream side passage 24 and the second downstream side passage 25.

Thus, the conditioned air whose temperature is adjusted to a desired temperature can be blown out from both the face opening 28 and the foot opening 30 toward the upper and lower sides of the passenger in the passenger compartment in the bi-level mode.

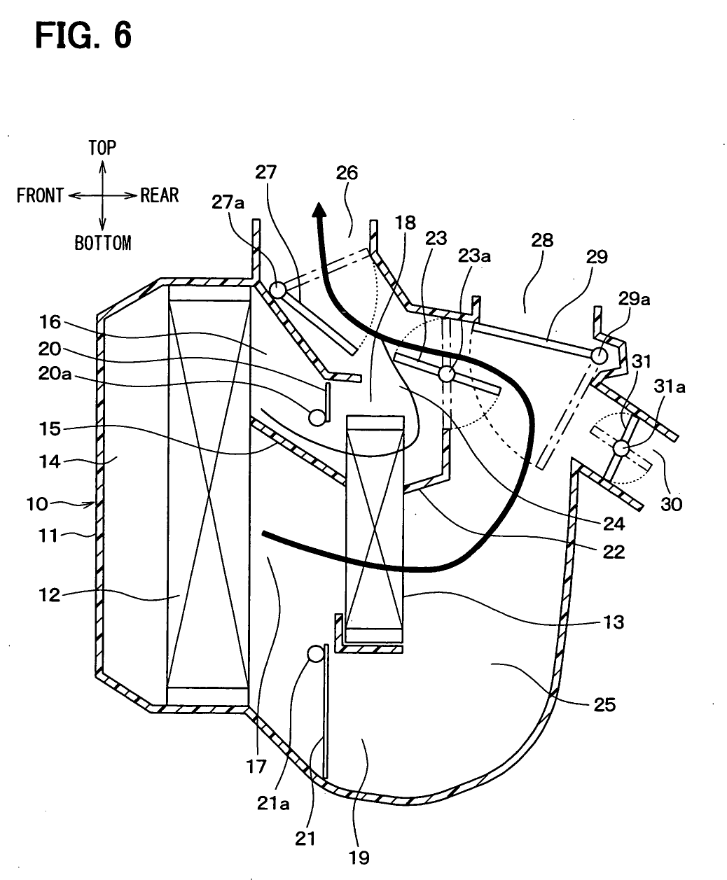

FIG. 6 shows a case of setting the defroster (DEF) mode as the air outlet mode. In the defroster mode, the defroster opening 26 is fully opened, and the first and second air mix doors 20 and 21 are set at the maximum heating positions at which the first and second bypass passages 18 and 19 are fully opened, as an example. In the defroster mode, the operation positions of the air mix doors 20 and 21 can be suitably changed so as to adjust the temperature of conditioned air.

In the defroster mode, the defroster opening 26 is fully opened by the defroster door 27, and the face opening 28 and the foot opening 30 are completely closed by the respective air outlet mode doors 29 and 31.

In cooperation with the switching to the defroster mode, the first switching door 23 is operated in the “communication position” for communicating the first downstream side passage 24 with the second downstream side passage 25 on the downstream side of the heater core 13 as indicated by the solid line in FIG. 6.

In this state, the cooled air cooled by the evaporator 12 passes through the upper and lower parts of the heater core 13 via the first and second upstream side passages 16 and 17 to become warm air. The warm air having passing through the upper part of the heater core 13 flows through the first downstream side passage 24 into the defroster opening 26. The warm air having passing through the lower part of the heater core 13 flows through the second downstream side passage 25 into the first downstream side passage 24, and then flows into the defroster opening 26.

In the present embodiment, the upstream side partition member 15 is provided such that the passage sectional area of the second upstream side passage 17 is larger than that of the first upstream side passage 16. Even in this case, it is possible to cause all warm air having passed through the first and second downstream side passages 24 and 25 to flow into the defroster opening 26.

As mentioned above, even when the defroster door 27 is not set at the small opening degree position in the foot mode, air is mainly blown from the foot opening 30, so that the flow amount of air flowing into the defroster opening 26 can be made small in the foot mode. Thus, the ratio of the flow amount of air flowing from the defroster opening 26 to the flow amount of air flowing from the foot opening 30 can be adjusted to an appropriate value, while suppressing the occurrence of abnormal noise or the like due to the defroster door 27 with the small opening degree position.

### Second Embodiment

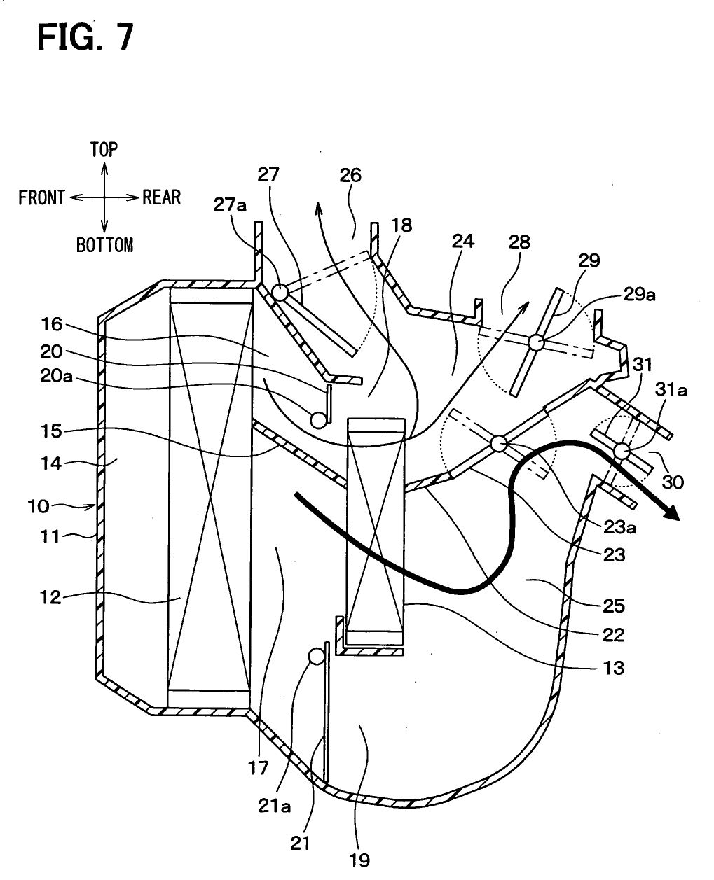

A second embodiment of the present invention will be described below based on FIG. 7. The second embodiment, the parts different from the first embodiment are mainly described. FIG. 7 is a schematic sectional view showing an air conditioning unit 10 of the second embodiment.

In the above-described first embodiment, the downstream side partition member 22 provided on the downstream air side of the heater core 13 and the first switching door 23 are located to form the first downstream side passage 24 for guiding air to the defroster opening 26, and the second downstream side passage 25 for guiding air to the face opening 28 and the foot opening 30.

In the second embodiment, as shown in FIG. 7, the downstream side partition member 22 and the first switching door 23 are configured, such that the first downstream side passage 24 serves as an air passage for guiding the air to the defroster opening 26 and the face opening 28, and the second downstream side passage 25 serves as an air passage for guiding the air to the foot opening 30. That is, the downstream side partition member 22 and the first switching door 23 are configured to partition the air passage into a space on the side of the defroster opening 26 and the face opening 28, and a space on the side of the foot opening 30.

As shown in FIG. 7, the downstream side partition member 22 is formed to extend from a position on an extension line of the downstream end of the upstream side partition member 15 that is positioned on the upstream air side of the heater core 13, and over the entire length of the internal space of the air conditioning case 11 in the vehicle width direction (i.e., in the direction orthogonal to the paper surface shown in FIG. 7.)

The first switching door 23 can be rotated to a position extending from the tip of the downstream side partition member 22 (from a downstream end opposite to the heater core 13) toward a wall surface of the air conditioning case 11 between the face opening 28 and the foot opening 30. That is, as shown in FIG. 7, the first switching door 23 can be rotated to a partition position, so that the air passage can be partitioned by the downstream side partition member 22 and the first switching door 23 into a first downstream side passage 24 capable of communicating with the defroster opening 26 and the face opening 28, and a second downstream side passage 25 capable of communicating with the foot opening 30.

In the present embodiment with the above-described arrangement, a multi-foot mode can be set as the air outlet mode. In the multi-foot mode of the present embodiment, a multi-mode in which the conditioned air is blown from the foot opening 30, the defroster opening 26, and the face opening 28 is applied to the foot mode described in the first embodiment. FIG. 7 shows a state of the air conditioning unit 10 in the multi-foot mode in which the conditioned air is blown from the foot opening 30, the defroster opening 26, and the face opening 28.

As shown in FIG. 7, the openings 26, 28 and 30 are fully opened by the respective air outlet mode doors 27, 29, and 31 in the multi-foot mode. In cooperation with the switching to the multi-foot mode, the first switching door 23 is operated in the “partition position” for separating the first downstream side passage 24 from the second downstream side passage 25 on the downstream side of the heater core 13 as indicated by the solid line in FIG. 7.

In this state, the air blown from the blower unit flows into the air inlet space 14, and then cooled by the evaporator 12 to become cooled air.

The cooled air passes through the upper part in the heater core 13 via the first upstream side passage 16 to become warm air. The warm air from the upper part in the heater core 13 flows into the defroster opening 26 and the face opening 28 through the first downstream side passage 24. At the same time, the air from the evaporator 12 passes through the lower part in the heater core 13 via the second upstream side passage 17 to become warm air. The warm air from the lower part in the heater core 13 flows into the foot opening 30 through the second downstream side passage 25.

Thus, in the multi-foot mode, the conditioned air can be mainly blown from the foot opening 30, while the small amount of conditioned air can be blown from the defroster opening 26 and the face opening 28. Even in this case, because the defroster opening 26 and the face opening 28 can be fully opened, a noise due to the defroster door 27 and the face door 29 with the small opening degrees can be prevented.

In the multi-foot mode, the defroster opening 26 and the face opening 28 are separated from the foot opening 30 by the downstream side partition member 22 and the first switching door 23, so that the operation positions of the first and second air mix doors 20 and 21 can be independently set. Thus, the temperature of air blown from the defroster opening 26 and the face opening 28 can be adjusted independently from the temperature of air blown from the foot opening 30.

In the second embodiment, the other parts of the air conditioning unit 10 may be similar to those of the air conditioning unit 10 of the above-described first embodiment.

### Third Embodiment

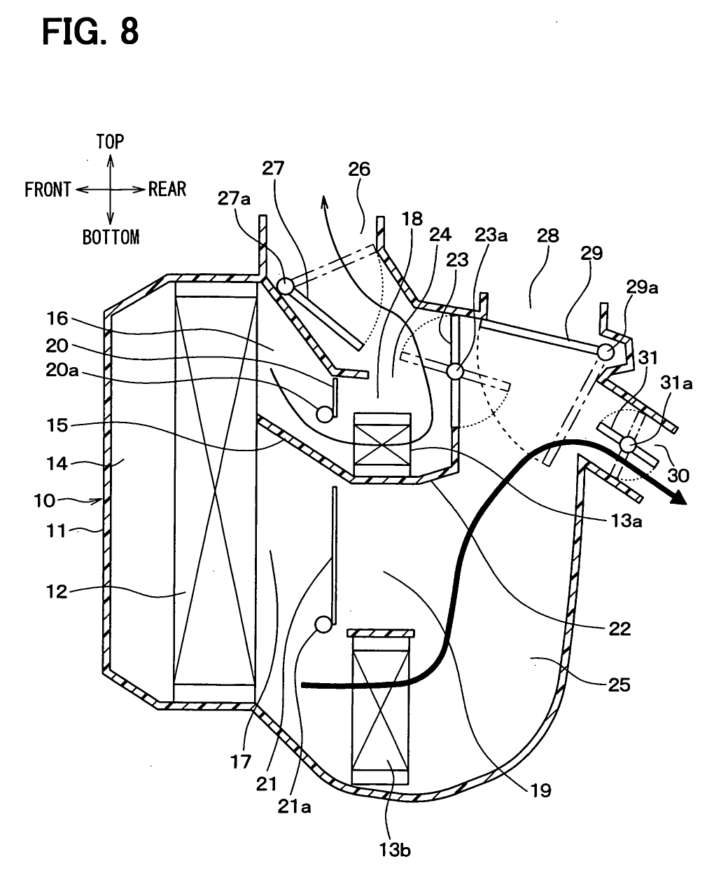

A third embodiment of the present invention will be described below based on FIG. 8. In the third embodiment, parts of an air conditioning unit 10 different from the first embodiment will be mainly described. FIG. 8 shows a schematic sectional view of the air conditioning unit 10 of the third embodiment in the foot mode.

In the above-described first embodiment, the air conditioning unit 10 includes only one heater core 13, and the heater core 13 is divided into the upper part and the lower part by the upstream and downstream partition members 15 and 22. In the third embodiment, the air conditioning unit 10 includes two heater cores 13a, 13b, which are separated from each other by a predetermined distance, as shown in FIG. 8.

In the present embodiment, the two heater cores 13a, 13b are arranged in parallel with respect to the air flow, and are constructed of an upper heater core (a first heat exchanger for heating) 13a disposed on the upper side of the air conditioning case 11, and a lower heater core (a second heat exchanger for heating) 13b disposed to be spaced from the upper heater core 13a by a predetermined distance on the lower side of the air conditioning case 11. Any one of the upper heater core 13a and the lower heater core 13b for use may be an electric heater or a water heater. As shown in FIG. 8, the upper heater core 13a and the lower heater core 13b are located to be partitioned and separated from each other.

An upstream side partition member 15 is formed to extend from the air outlet side of the evaporator 12 toward the lower end of the upper heater core 13a. The upstream side partition member 15 is provided to form a first upstream side passage 16 for allowing the air to flow into the upper heater core 13a and the first bypass passage 18, and a second upstream side passage 17 for allowing the air to flow into the lower heater core 13b and the second bypass passage 19.

The first bypass passage 18 through which the air from the evaporator 12 flows while bypassing the upper heater core 13a is formed above the upper heater core 13a in an air passage in the air conditioning case 11. The second bypass passage 19 through which the air from the evaporator 12 flows while bypassing the lower heater core 13b is formed between the upper heater core 13a and the lower heater core 13b.

The downstream side partition member 22 is formed at a position on an extension line at the vehicle rear of the first upstream side partition member 15 to extend upward from the lower end of the upper heater core 13a, as shown in FIG. 8.

With the above-described arrangement, in the foot mode, the air cooled by the evaporator 12 flows from the first upstream passage 16 into the upper heater core 13a to become warm air. The warm air is blown out toward the vehicle windshield via the first downstream side passage 24, the defroster opening 26, the defroster duct, and the defroster air outlet in that order.

At the same time, the cooled air flows from the second upstream side passage 17 into the lower heater core 13b to become warm air. The warm air is blown out toward the lower body of the passenger in the passenger compartment through the second downstream side passage 25, the foot opening 30, the foot duct, and the foot air outlet in that order.

Thus, the present embodiment differs from the above-described first embodiment in that the air conditioning unit 10 includes two heater cores, namely, the upper heater core 13a and the lower heater core 13b. Even this arrangement can exhibit the same effects as those of the first embodiment.

In the present embodiment, the air conditioning unit 10 including the two heater cores 13a and 13b is used for the foot mode described in the first embodiment. Alternatively, the air conditioning unit 10 including the two heater cores 13a and 13b can be used for the multi-foot mode described in the second embodiment. That is, the heater cores 13a and 13b separated from each other may be used instead of the single heater core 13 of the above-described first embodiment, or may be used instead of the single heater core 13 of the above-described second embodiment.

### Fourth Embodiment

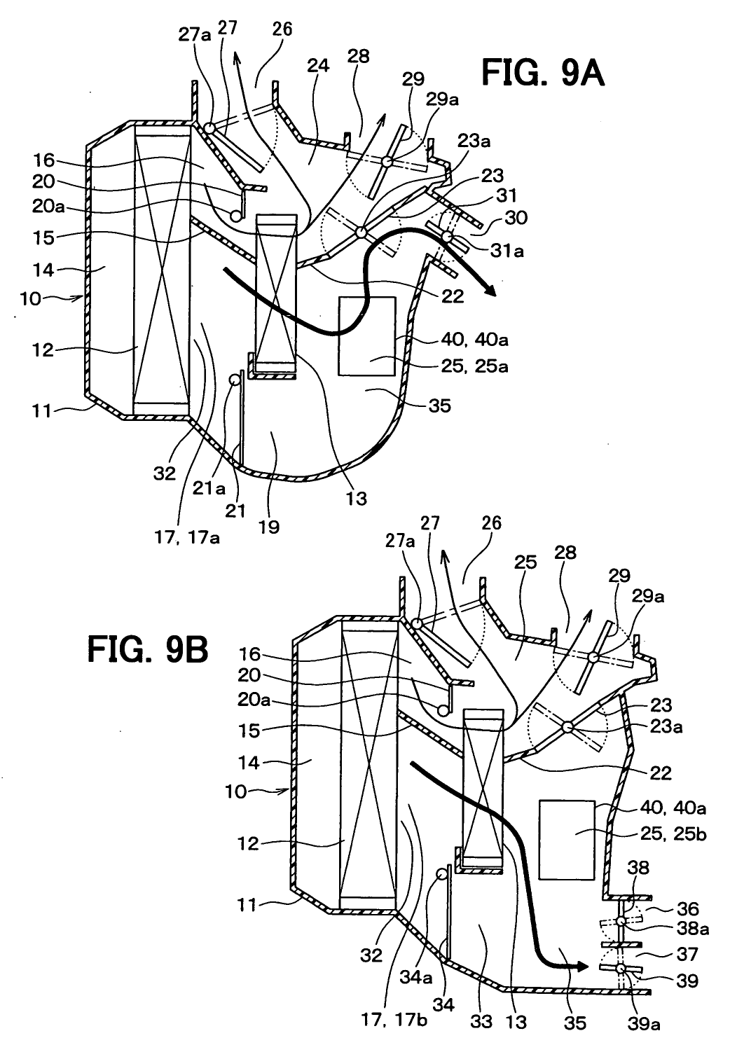

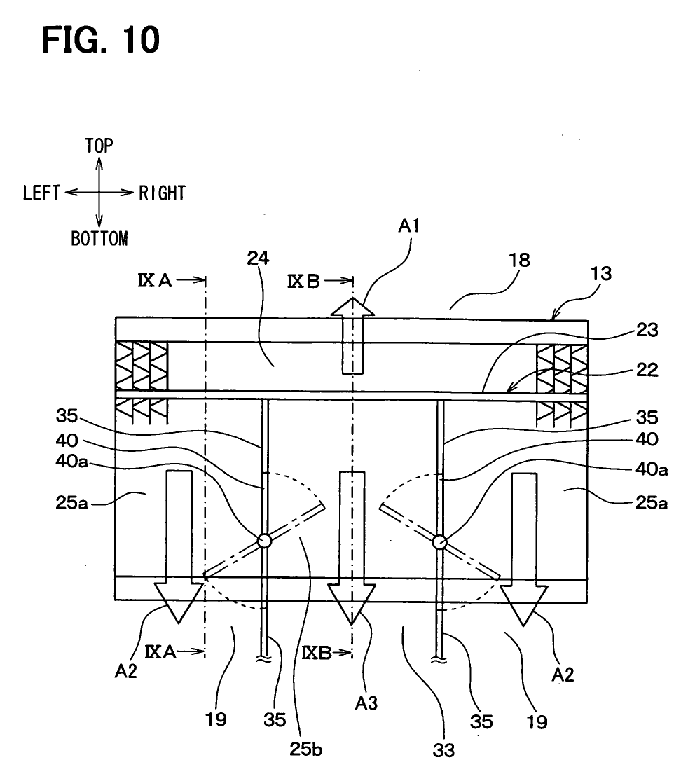

A fourth embodiment of the present invention will be described below based on FIGS. 9A, 9B, and 10. In the fourth embodiment, parts of an air conditioning unit 10 different from the air conditioning unit 10 of the above-described second embodiment will be mainly described. FIG. 9A is a cross-sectional view taken along the line IXA-IXA in FIG. 10, and FIG. 9B is a cross-sectional view taken along the line IXB-IXB in FIG. 10.

In the present embodiment shown in FIGS. 9A and 9B, the air conditioning unit 10 is provided with rear seat side openings 36, 37, in addition to the air outlet openings 26, 28, and 30 described in the second embodiment.

In the present embodiment, a second upstream side passage 17 on the upstream air side of a lower part of the heater core 13 is divided into upstream side passages 17a for a front seat on both the left and right sides (see FIGS. 9A and 10) and an upstream side passage 17b for a rear seat at the center area (see FIGS. 9B and 10) in the vehicle left-right direction by using two second upstream side partition members 32. In the fourth embodiment, the upstream side partition member 15 of the above-described second embodiment is used as a first upstream side partition member 15. Each of the second upstream side partition members 32 is constructed of a plate-shaped member, in the air conditioning case 11. The two second upstream side partition members 32 are formed to extend from the air outlet side of the evaporator 12 toward the air inlet side of the lower part of the heater core 13, so that the second upstream side passage 17 is divided into the upstream side passages 17a for the front seat on the left and right sides, and the upstream side passage 17b for the rear seat between the left and right upstream side passages 17a in the vehicle left-right direction.

The first upstream side partition member 15 is formed to extend over the entire length of the internal space of the air conditioning case 11 in the vehicle left-right direction. On the other hand, the two second upstream side partition members 32 constructed of two plate-shaped members are disposed in parallel to be spaced apart from each other by a predetermined distance in the vehicle left-right direction. Each of the second upstream side partition members 32 is located to extend over the entire length of the internal space of the air conditioning case 11 in the vehicle vertical direction (vehicle top-bottom direction). The lower part of the heater core 13 is further partitioned into left and right portions and a center portion in the vehicle left-right direction, by the second upstream side partition members 32 and second downstream side partition member 35 to be described later.

The second bypass passages 19 are provided below left and right portions of the lower part of the heater core 13, as shown in FIGS. 9A and 10. Therefore, air having passed through the upstream side passages 17a for the front seat flows into the second bypass passages 19 as shown in FIG. 9A. A third bypass passage 33 for allowing the air (cooled air) to flow while bypassing the lower part of the heater core 13 is provided below the center portion of the lower part of the heater core 13. Therefore, the air having passed through the upstream side passage 17b for the rear seat flows into the third bypass passage 33 while bypassing the lower part of the heater core 13 as shown in FIG. 9B.

In the present embodiment, second air mix doors 21 are disposed between the evaporator 12 and the left and right portions of the lower part of the heater core 13 (see FIG. 9A), and a third air mix door 34 is disposed between the evaporator 12 and the center portion of the lower part of the heater core 13 (see FIG. 9B). The third air mix door 34 may be constructed of a flat plate-shaped sliding door that is movable by a driving transmission mechanism, such as a driving gear 34a.

As shown in FIG. 10, the two plate-shaped downstream side partition members 35 are provided on the downstream air side of the lower part of the heater core 13. The partition member 35 extends toward the rear side of the air conditioning case 11 from a position on an extension line at the vehicle rear of the second upstream side partition member 32 that is positioned on the upstream air side of the lower part of the heater core 13.

In the present embodiment, the downstream side partition member 22 described in the second embodiment is used as a first downstream side partition member 22. The first downstream side partition member 22 is formed to extend over the entire length of the internal space of the air conditioning case 11 in the vehicle left-right direction. The two plate-shaped second downstream side partition members 35 are provided in parallel to the air flow to be spaced from each other by a predetermined distance in the vehicle left-right direction. Each of the second downstream side partition members 35 is formed to extend over the entire length of the internal space of the air conditioning case 11 in the vehicle top-bottom direction.

The first switching door 23 is provided between the downstream tip of the first downstream side partition member 22 and an upper wall surface of the air conditioning case 11. A second switching door 40 is provided substantially at a center area of the wall surface of the second downstream side partition member 35. The second switching door 40 is configured to be rotatable around a rotary shaft 40a, for example.

As shown in FIGS. 9A, 9B and 10, the second downstream side partition members 35 are formed on the downstream air side of the lower part of the heater core 13. The second downstream side partition member 35 extends from a position on an extension line at the vehicle rear of the second upstream side partition member 32 toward the wall surface of the air conditioning case 11 between the rear seat side openings 36 and 37 that are provided on the lower side of the front seat side foot opening 30 of the case 11.

In the rear seat side face openings 36 and 37, the rear side face opening 36 is for blowing the conditioned air toward the upper body of the passenger on the rear seat in the passenger compartment, and the rear seat side foot opening 37 is for blowing the conditioned air toward the lower body of the passenger on the rear seat in the passenger compartment. The rear seat side face opening 36 is opened and closed by a plate-shaped rear seat side face door 38 which is rotatable around a rotary shaft 38a. The rear seat side foot opening 37 is opened and closed by a plate-shaped rear seat side foot door 39 which is rotatable around a rotary shaft 39a.

The rear seat side openings 36 and 37, each of which is connected to a face duct for the rear seat and a foot duct for the rear seat, are not shown. A face air outlet for the rear seat, and a foot air outlet for the rear seat are provided at the lower end of the duct for the rear seat. The conditioned air is blown from any the air outlet for the rear seat toward the passenger on the rear seat in the passenger compartment.

In the second downstream side passage 25, left and right downstream side passages 25a for a front seat (an air passage for the front seat), and a downstream side passage 25b for the rear seat (an air passage for the rear seat) are formed by the second downstream side partition members 35 and the second switching doors 40, as shown in FIG. 10. The second downstream side partition members 35 and the second switching doors 40 are configured to define the downstream side passage 25b for the rear seat between the left and right downstream side passages 25a for the front seat, in the vehicle left-right direction. Each of the left and right downstream side passages 25a is adapted to guide the conditioned air to the foot opening 30 for the front seat, as shown by the arrows A2 in FIG. 10. The downstream side passage 25b is adapted to guide the conditioned air to the openings 36 and 37 on the rear seat side, as shown by the arrow A3 in FIG. 10. In FIG. 10, the arrow A1 indicates the air flow toward the side of the defroster opening 26 and the face opening 28.

The first switching door 23 is disposed so as to enable communication between the first downstream side passage 24, and the second downstream side passage 25 including the air passages 25a and 25b for the front and rear seats. The second switching door 40 is disposed so as to enable communication between the downstream side passage 25a for the front seat and the downstream side passage 25b for the rear seat.

The second switching door 40 is rotated based on a detection value detected by a passenger detector such as a seating sensor or the like (not shown) for detecting presence or absence of a passenger on the rear seat. The operation of the second switching door 40 is performed by using a signal from the passenger detector, but is not limited thereto. Any other structure generally known may be used to operate the second switching door 40. For example, the second switching door 40 may be rotated when the foot mode is set as the air outlet mode by an air outlet mode switching device in a case where the passengers exist on the front and rear seats in the passenger compartment.

When the passenger on the rear seat is detected by the passenger detector, the second switching door 40 is operated to a “partition position” (a position indicated by the solid line shown in FIG. 10) for interrupting the communication between the first downstream side passage 24 and the downstream side passage 25b for the rear seat. On the other hand, when the passenger detector does not detect the passenger on the rear seat in the passenger compartment, the second switching door 40 is located in the “communication position” (a position indicated by the dashed line shown in FIG. 10) for communicating the first downstream side passage 24 with the downstream passage 25b for the rear seat.

With the arrangement of the air conditioning unit 10 in the present embodiment, as shown in FIGS. 9A and 9B, when there is the passenger on the rear seat side of the passenger compartment in the foot mode, the conditioned air can be blown not only from the defroster opening 26 and the foot opening 30 for the front seat, but also from the foot opening 37 for the rear seat.

In the fourth embodiment, the openings 36 and 37 for the rear seat are provided in the air conditioning unit 10, unlike the second embodiment. Even this arrangement of the air conditioning unit 10 can obtain the effects described in the second embodiment.

When there is no passenger on the rear seat side, the conditioned air flowing into the openings 36 and 37 for the rear seat can be blown from the opening 30 for the front seat by arranging the second switching door 40 in the communication position. Therefore, it is possible to improve air conditioning capacity and air conditioning efficiency.

In the present embodiment, the openings 36 and 37 for the rear seat are provided in the air conditioning unit 10 corresponding to the multi-foot mode described in the second embodiment. Alternatively, the present embodiment can be applied to the air conditioning unit 10 corresponding to the foot mode, as described in the first embodiment. That is, the structure for the rear seat described in the fourth embodiment may be applied to any the above-described first or second embodiment.

### Fifth Embodiment

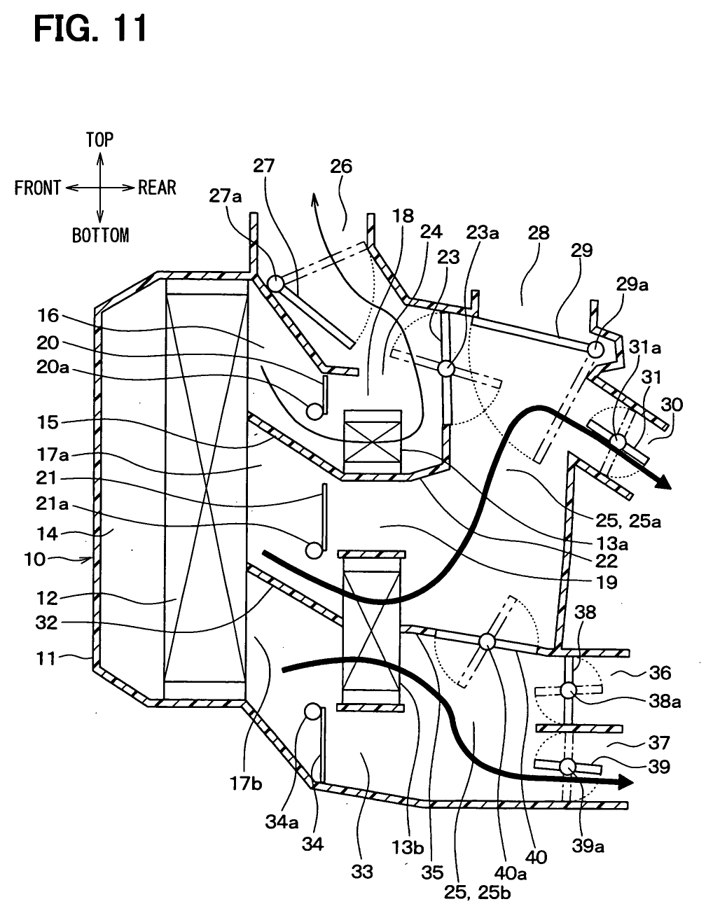

A fifth embodiment of the present invention will be described later based on FIG. 11. The fifth embodiment differs from the third embodiment mainly in the following points. FIG. 11 is a sectional view of an air conditioning unit 10 of the fifth embodiment.

In the fifth embodiment, the air conditioning unit 10 includes air outlet openings for the rear seat, in addition to the defroster opening 26, the face opening 28 and the foot opening 30 on the front seat side of the air conditioning unit 10 described in the third embodiment. That is, in the fifth embodiment, an air blowing-out structure for the rear seat is applied to the air conditioning unit 10 of the third embodiment.

In the fifth embodiment, the upstream side partition member 15 is used as a first upstream side partition member to partition the first upstream side passage 16 and the second upstream side passage 17 from each other. Furthermore, the second upstream side passage 17 on the upstream air side of the lower heater core 13b is divided into an upstream side passage 17a for the front seat and an upstream side passage 17b for the rear seat by a second upstream side partition member 32 in the air conditioning case 11, as shown in FIG. 11.

The second upstream side partition member 32 is formed to extend from the air outlet side of the evaporator 12 to an air inlet side of the lower heater core 13b, and over the entire length of the internal space of the case 11 in the vehicle left-right direction (i.e., in the direction orthogonal to the paper surface of FIG. 11). Further, the lower heater core 13b is partitioned into an upper part and a lower part of the lower heater core 13b by the second upstream side partition member 32 and a second downstream side partition member 35 to be described later.

The second bypass passage 19 is provided above the lower heater core 13b, like the third embodiment. A third bypass passage 33 through which the air (cooled air) flows while bypassing the lower heater core 13b is further provided below the lower heater core 13b.

The second air mix door 21 is disposed between the evaporator 12 and a portion above the lower heater core 13b, and a third air mix door 34 is disposed between the evaporator 12 and a portion below the lower heater core 13b. The third air mix door 34 is constructed of a flat plate-shaped sliding door that is moved by a driving transmission mechanism, such as a driving gear 34a.

The second downstream side partition member 35 is provided on the downstream air side of the lower heater core 13b. The second downstream side partition member 35 extends from a position on an extension line at the vehicle rear of the second upstream side partition member 32 that is located on the upstream air side of the lower heater core 13b toward the rear side of the air conditioning case 11, as shown in FIG. 11.

A second switching door 40 is provided to extend from the rear tip of the second downstream side partition member 35 (an end opposite to the heater core 13) toward a wall surface of the air conditioning case 11 positioned between the front seat side foot opening 30 and the rear seat side openings 36 and 37 provided below the foot opening 30 of the air conditioning case 11.

The rear seat side openings 36 and 37 include the rear seat side face opening 36 for blowing out the conditioned air toward the upper body of the passenger on the rear seat in the passenger compartment, and the rear seat side foot opening 37 for blowing out the conditioned air toward the lower body of the passenger on the rear seat in the passenger compartment. The rear seat side face opening 36 is opened and closed by the plate-shaped face door 38 on the rear seat side which is rotatable around the rotary shaft 38a. The rear seat side foot opening 37 is opened and closed by the plate-shaped foot door 39 which is rotatable around the rotary shaft 39a.

The rear seat side openings 36 and 37 are connected to a face duct for the rear seat (not shown) and to a foot duct for the rear seat (not shown), respectively. The face air outlet and the foot air outlet for the rear seat (not shown) are provided at a lower end of the duct for the rear seat for blowing out the conditioned air from the air outlet for the rear seat into the passenger on the rear seat in the passenger compartment.

In the second downstream side passage 25, a downstream side passage 25a for the front seat for guiding the conditioned air to the front seat side foot opening 30, and a downstream side passage 25b for the rear seat for guiding the conditioned air to the rear seat side openings 36 and 37 are formed to be partitioned by the second downstream side partition member 35 and the second switching door 40. The second switching door 40 is rotatably disposed around the rotary shaft 40a. The second switching door 40 is adapted to rotate based on a detection signal from a passenger detector. The passenger detector is, for example, a standing sensor or the like (not shown), for detecting the presence or absence of a passenger on the rear seat of the passenger compartment. The operation of the second switching door 40 is performed by using a detection signal of the passenger detector, but is not limited thereto. Any other structure generally known may be used to operate the second switching door 40.

A rear seat side passenger can be detected by the passenger detector. When the second switching door 40 is operated in the position indicated by the solid line of FIG. 11, the second switching door 40 is set at the “partition position” for interrupting the communication between the downstream side passage 25a for the front seat and the downstream side passage 25b for the rear seat. On the other hand, when the second switching door 40 is rotated to the position indicated by the dashed line of FIG. 11 in a case without detecting the rear side passenger by the passenger detector, the second switching door 40 is set at the “communication position” for communicating the second downstream side passage 24 with the third downstream side passage 25.

In the present embodiment with the above-described arrangement, as shown in FIG. 11, when the passenger sits on the rear seat of the passenger compartment in the foot mode, the conditioned air can be blown out from the foot opening 37 for the rear seat in addition to the defroster opening 26 and the foot opening 30 for the front seat.

The air conditioning unit 10 of the present embodiment is provided with the openings 36 and 37 for the rear seat, unlike the third embodiment. In even in this case, the present embodiment with this arrangement can exhibit the same effects as those of the third embodiment.

When no passenger sits on the rear seat of the passenger compartment, the second switching door 40 is placed in the communication position, so that the conditioned air flowing toward the openings 36 and 37 for the rear seat is allowed to be blown from the foot opening 30 for the front seat, thereby enabling improvement of the air conditioning efficiency.

In the fifth embodiment, the other parts of the air conditioning unit 10 may be similar to those of the above-described third embodiment.

### Sixth Embodiment

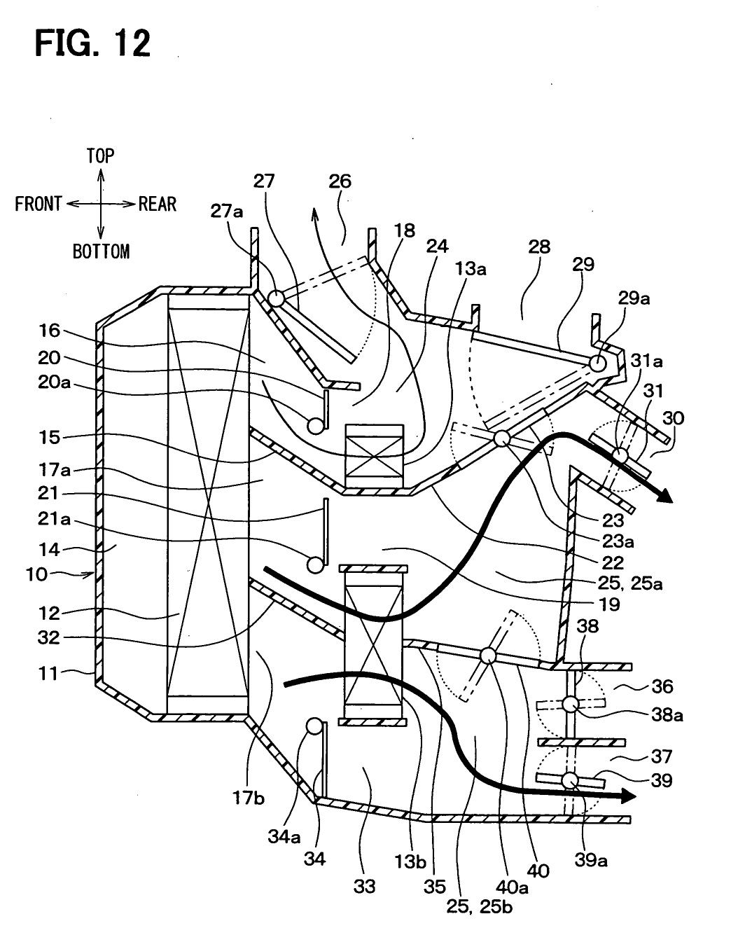

A sixth embodiment of the present invention will be described based on FIG. 12. The sixth embodiment differs from the fifth embodiment mainly in the following points. FIG. 12 is a schematic sectional view of an air conditioning unit 10 in the foot mode according to the sixth embodiment.

In the sixth embodiment, the air conditioning unit 10 corresponding to the multi-foot mode described in the second embodiment is applied to the fifth embodiment.

Thus, the air conditioning unit 10 corresponding to the multi-foot mode is provided with an opening for the rear seat, so that the conditioned air can be mainly blown from the foot opening 30 for the front seat and the foot opening for the rear seat, while a small amount of conditioned air can be blown from the defroster opening 26 and the face opening 28.

### Other Embodiments

Although the present invention has been fully described in connection with the preferred embodiments thereof with reference to the accompanying drawings, it is to be noted that various changes and modifications will become apparent to those skilled in the art.

(1) In the above-described embodiments, the air conditioner is a so-called air-mix type air conditioner in which the temperature of conditioned air is adjusted by adjustment of the ratio of the flow amount of warm air to that of cooled air. Alternatively, the air conditioner of the present invention can be applied to a so-called reheat-type air conditioner for adjusting the temperature of conditioned air by adjustment of the amount of heat generated by the heater core 13. For example, the temperature of air to be blown into the passenger compartment can be adjusted to a desired temperature by adjusting a flow rate of hot water flowing into the heater core 13.

(2) Although in the above-described embodiments, each of the air mix doors 20, 21, and 34 is constructed of the sliding door, the present invention is not limited thereto. A plate door, a film door, a rotary door or the like can be used for the air mix door 20, 21 or 34. Although the air outlet mode doors and the first and second switching doors 23 and 40 corresponding to the respective openings for use are respectively constructed of the plate doors, the present invention is not limited thereto. A sliding door, a film door, or the like can be used for the air outlet mode doors and the switching doors.

(3) In the above-described fifth and sixth embodiments, the second upstream side partition member 32 may be formed to extend up to the internal space of the lower heater core 13b and to be connected to the second downstream side partition member 35, thereby partitioning the lower heater core 13b into an upper part of the lower heater core 13b and a lower part of the lower heater core 13b.

(4) The features of the above-described embodiments of the present invention may be suitably combined without being limited to the detail examples.

Such changes and modifications are to be understood as being within the scope of the present invention as defined by the appended claims.

What is claimed is:

1. An air conditioner for a vehicle, comprising:
an air conditioning case defining therein an air passage through which air flows toward an inside of a passenger compartment of the vehicle;
a foot opening portion provided in the air conditioning case, from which air is blown out toward a lower side in the passenger compartment;
a foot door configured to open and close the foot opening portion;
a defroster opening portion provided in the air conditioning case, from which air is blown toward a windshield of the vehicle;
a defroster door configured to open and close the defroster opening portion;
a first downstream side passage provided in the air passage of the air conditioning case to guide air to the defroster opening portion;
a second downstream side passage provided in the air passage of the air conditioning case to guide air to the foot opening portion;
a first switching door configured to be capable of switching between a partition position for partitioning the first downstream side passage and the second downstream side passage from each other, and a communication position for establishing communication between the first downstream side passage and the second downstream side passage; and
an air outlet mode switching device configured to be capable of switching between a foot mode in which air is mainly blown from at least one foot opening portion while a small amount of air is blown from the defroster opening portion, and a foot/defroster mode in which a flow amount of air blown from the foot opening portion is decreased thereby to increase a flow amount of air blown from the defroster opening portion as compared with the foot mode,
wherein, in the foot mode, the air outlet mode switching device opens both the foot door and the defroster door and sets the first switching door in the partition position to guide air passing through the first downstream side passage to the defroster opening portion, and to guide air passing through the second downstream side passage to the foot opening portion, and
wherein, in the foot/defroster mode, the air outlet mode switching device opens both the foot door and the defroster door and sets the first switching door in the communication position to guide air passing through the first downstream side passage and a part of air passing through the second downstream side passage to the defroster opening portion, and to guide the remaining air passing through the second downstream side passage to the foot opening portion.

2. The air conditioner for a vehicle according to claim 1, further comprising:
a face opening portion provided in the air conditioning case, from which air is blown toward an upper side in the passenger compartment; and
a face door configured to open and close the face opening portion,
wherein the first downstream side passage is provided to guide air in the first downstream side passage to the face opening portion in addition to the defroster opening portion, and
wherein, in the foot mode, the air outlet mode switching device opens the face door, the foot door and the defroster door and causes the first switching door to be set at the partition position to guide air passing through the first downstream side passage to both the defroster opening portion and the face opening portion, and to guide air passing through the second downstream side passage to the foot opening portion.

3. The air conditioner for a vehicle according to claim 1, further comprising:
a cooling heat exchanger located in the air conditioning case to cool air;
a heating heat exchanger located in the air conditioning case to heat air after passing through the cooling heat exchanger; and
a partition member configured to partition the air passage between the cooling heat exchanger and the heating heat exchanger into first and second upstream side passages,
wherein the first downstream side passage allows the air having passed through the first upstream side passage and the heating heat exchanger to flow thereinto,
wherein the second downstream side passage allows the air having passed through the second upstream side passage and the heating heat exchanger to flow thereinto, and
wherein the partition member is configured such that a flow amount of the air passing through the first upstream side passage is smaller that a flow amount of the air passing through the second upstream side passage.

4. The air conditioner for a vehicle according to claim 3, wherein the heating heat exchanger is a single integrated heat exchanger, and
wherein the heating heat exchanger is disposed, such that the air passing through the first upstream side passage flows into a part of the heating heat exchanger on one end side, and the air passing through the second upstream side passage flows into another part of the heating heat exchanger on the other end side.

5. The air conditioner for a vehicle according to claim 3, wherein the heating heat exchanger includes first and second heater cores separated from each other,
wherein the first heater core is disposed to allow the air passing through the first upstream side passage to flow thereinto, and
wherein the second heater core is disposed to allow the air passing through the second upstream side passage to flow thereinto.

6. The air conditioner for a vehicle according to claim 1, wherein the second downstream side passage is provided with a front seat air passage and a rear seat air passage, the air conditioner further comprising
a second switching door configured to be switched between a partition position for separating the front seat air passage from the rear seat air passage, and a communication position for establishing communication between the front air passage and the rear seat air passage,
wherein the foot opening portion includes a front seat foot opening for allowing the air having passed through the front seat air passage to be blown out toward the lower body of a passenger on a front seat in the passenger compartment, and a rear seat foot opening for allowing the air having passed through the rear seat air passage to be blown out toward the lower body of a passenger on a rear seat in the passenger compartment,
wherein the foot door includes a front seat foot door configured to open and close the front seat foot opening, and a rear seat foot door configured to open and close the rear seat foot opening, and
wherein the second switching door is set at the partition position when both the front seat foot door and the rear seat foot door are opened.

7. The air conditioner for a vehicle according to claim 1, further comprising:
a face opening portion provided in the air conditioning case, from which air is blown toward an upper side in the passenger compartment; and
a face door configured to open and close the face opening portion,
wherein the first downstream side passage is provided to guide air in the first downstream side passage to the defroster opening portion, and
wherein, in the foot mode, the air outlet mode switching device closes the face door and opens the foot door and the defroster door, and causes the first switching door to be set at the partition position to guide air passing through the first downstream side passage to the defroster opening portion, and to guide air passing through the second downstream side passage to the foot opening portion.

8. The air conditioner for a vehicle according to claim 1, wherein the air outlet mode switching device is configured to fully open the foot door and to open the defroster door by an opening degree larger than a predetermined degree, in the foot mode.

9. The air conditioner for a vehicle according to claim 8, wherein the air outlet mode switching device is configured to fully open the foot door and to open the defroster door by an opening degree equal to or larger than half, in the foot mode.

10. The air conditioner for a vehicle according to claim 1, wherein the air outlet mode switching device is configured to fully open both the foot door and the defroster door, in the foot mode and in the foot/defroster mode.

11. The air conditioner for a vehicle according to claim 3, wherein first downstream side passage and the second downstream side passage are provided in the air conditioning case downstream of the heating heat exchanger.
